(19) United States
(12) Patent Application Publication
(10) Pub. No.: US 2015/0142516 A1
(43) Pub. Date: May 21, 2015

(54) ALLOCATION FOR RETAIL ITEMS

(71) Applicant: ORACLE INTERNATIONAL CORPORATION, Redwood Shores, CA (US)

(72) Inventors: Mark SCHWANS, Rosemount, MN (US); Gerald Joseph HANSON, Apple Valley, MN (US); Renjith MOOLAYIL, Edina, MN (US)

(21) Appl. No.: 14/086,206

(22) Filed: Nov. 21, 2013

(51) Int. Cl. G06Q 10/08; G06Q 30/02

(52) U.S. Cl. CPC G06Q 10/087; G06Q 30/0202
USPC 705/7.31

(57) ABSTRACT

Systems, methods, and other embodiments associated with allocation of retail goods based on a size profile and/or a selected strategy are described. In one embodiment, a method includes receiving a demand quantity for an item sold in multiple SKUs and accessing a size profile that specifies a relative contribution of a plurality of SKUs to overall sales of the items. Respective SKU demand contributions are determined for respective SKUs, based on the size profile. The method includes applying the respective SKU demand contributions to the demand quantity to calculate a plurality of SKU demands. In one embodiment, the method includes determining a selected substitution strategy. The items are allocated to fulfill the demand quantity for the item based on the plurality of SKU demands and the selected strategy.

### BACKGROUND

As retailers continue to improve their supply chain efficiency and offer more localized assortments, they work with their vendors to pre-package many of their items into packs having specific assortments of item stocking keeping units (SKUs). This allows for easier handling and cross-docking through a warehouse, as handling a “box” or “crate” is much more efficient than handling individual items. In the fashion industry, where items come in SKUs that correspond to individual size and color combinations, the SKU assortment in the packs aims to ensure that the right sizes and colors are packaged together by the vendor and passed through the warehouse before the packs are sent to the retail stores. While lowering handling costs and improving inventory accuracy, the use of packs containing assorted items “locks in” the color/size distribution of the items in the packs and thus brings with it some allocation related challenges.

The decision as to the SKU assortment in the packs is typically made months ahead of the selling season and is based on a prediction of what consumers will buy and in what relative quantities. The inflexibility of the assorted packs makes it difficult to adjust allocation quantities closer to release time when a different SKU distribution of items may be desired. Also, during in season allocation it is difficult to re-stock on those SKUs that sold well because popular SKUs are packaged with less popular SKUs. The challenge is exacerbated when multiple colors are grouped together. If whites sold well but yellows did not, it becomes more challenging to allocate packs to the proper customer demand when the yellows and whites are packaged together.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of an allocation tool that allocates retail goods.

FIG. 2 illustrates an example embodiment of a method associated with size profile based allocation.

FIG. 3 extends FIG. 2 and is an example embodiment of a method associated with a defined strategy within an allocation.

FIGS. 4 and 5 illustrate an example of fashion retail items being allocated by the system of FIG. 1.

FIG. 6 illustrates an embodiment of a computing system in which example systems and methods, and equivalents, may operate.

### DETAILED DESCRIPTION

By determining the best combination of inventory “just-in-time” for need, businesses align inventory to consumer demand and still take advantage of all the supply chain efficiency of pre-packaged assortments of items having multiple SKUs that can consist of multiple sizes and/or multiple colors (for simplicity, hereinafter an item having a given SKU may be referred as simply a “SKU”). Multi-SKU packs offer the advantages just described but significantly reduce flexibility in distributing SKUs to various retail stores as conditions change. For example, in the fashion industry the SKU assortment in a pack is decided six to nine months prior to the selling season. However many factors impact which specific SKU combinations should be sent to specific stores at different points in the selling season, making the allocation process difficult, especially when packs have already been packaged with multi-SKU assortments.

One factor that impacts the optimum combination of SKUs to ship to a given store is that different stores sell different distributions of sizes for a given item. Thus, each store has a “size profile” for the items it sells. The size profile is used to generate a SKU demand from an aggregated parent item, or style. A style is a generic representative of a particular item. If the style is blouse, the SKUs are the specific color and size combinations for the blouse, for example a medium white blouse or a small black blouse. The size profile represents a size distribution of past sales in a particular store of different SKUs for an item. While the term “size profile” will be used throughout this description and examples will be in a fashion context, the systems and methods herein are also suitable for use in any industry in which multiple SKUs are present for a given item and stores sell different distributions of the SKUs (e.g., upholstery color for furniture might be sold according to a color profile, flavors of ice cream according to a flavor profile, and so on).

Another factor that impacts the optimum combination of SKUs to ship to a given store is that different retailers and/or stores have different substitution strategies. Some retailers may choose to limit markdowns by avoiding overstocking on less popular SKUs, even at the cost of not completely filling the demand for more popular SKUs. This represents a “no substitution” strategy with respect to the store's size profile. Other stores may choose to “fill the shelves” and drastically mark down over-stocked SKUs. This represents a “substitution allowed” strategy. In a sense, the substitution strategy is a choice as to whether or not to honor the individual SKU demand generated by the size profile. Store specific substitution strategies and changing size profiles make it difficult to allocate packs properly, especially mid season. Often, an allocator had to manually allocate packs for each store in an attempt to match the store's size profile demand and substitution strategy while taking into consideration the SKU assortment in the packs.

The systems, tools, and methods described herein introduce a size profile and, in some embodiments, a substitution strategy as inputs to an automatic allocation process. This greatly improves the flexibility that can be provided by the automatic allocation process. The size profile and substitution strategy for a specific store is input to the allocation process at the time of allocation so that the most recent size profile and substitution strategy can be leveraged when making real-time allocations.

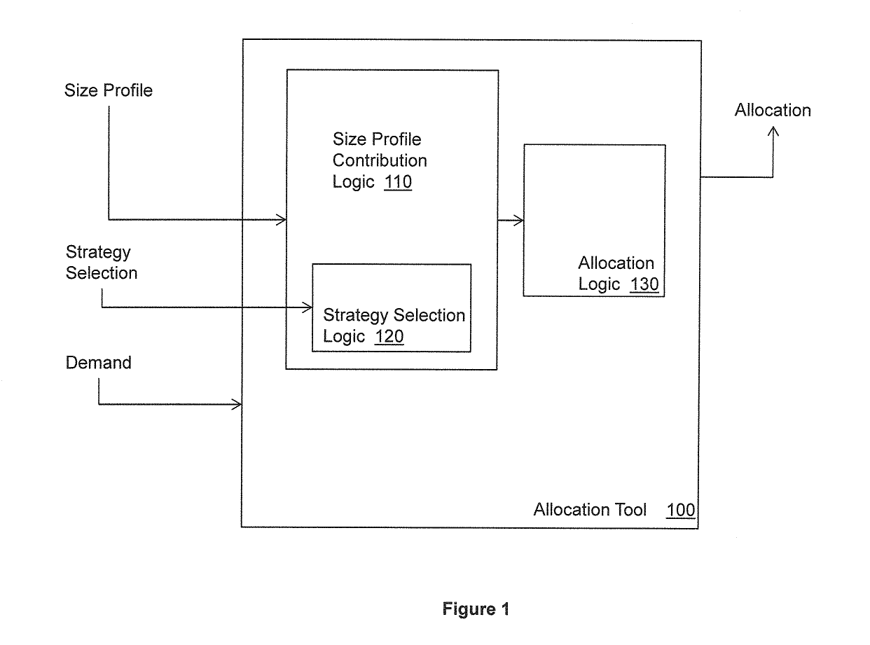

With reference to FIG. 1, one embodiment of an allocation tool 100 that performs allocation of retail items is illustrated. The allocation tool 100 is configured to be used in conjunction with a computer processor (not shown) and the allocation tool 100 causes the processor to perform various allocation-related actions. The multiple logics of the allocation tool 100 may be implemented as an ASIC or computer-executable instructions stored on a non-transitory computer-readable medium that is installed in or otherwise read by the processor.

To allocate an item, the allocation tool 100 inputs a size profile for the item, a strategy selection for the item, and a demand for the item. The allocation tool 100 outputs an allocation for the item that takes into consideration the size profile and substitution strategy for the item.

Each SKU labels a unique item such that items having the same SKU are considered interchangeable for inventory purposes. The concept of the size profile used herein as an input to the allocation tool 100 does not have to be a profile of sales on a strictly per SKU basis. Size profiles may be conceptualized as being hierarchical in nature, with aggregated styles or style/colors of various SKUs representing a distribution of SKUs. The most granular size profile for a given item may be selected for use in allocation of the item.

Consider a skirt that comes in multiple sizes and colors such that each SKU is a single size/color combination. The size profile used to allocate skirts is selected based on the granularity of profile data that is available skirts. For example, some stores may not generate size profiles for skirts on a per size/color combination basis. The generation of size profiles often involves smoothing out lost sales and normalizing history across time to derive up with a statistical representation of those sales. This requires accurate sales data and extensive processing. If a detailed style/color size profile is not available, a color-agnostic size level size profile for ladies skirts is used for allocation.

In some stores, a color specific size profile may be available for each size/color combination. In these stores, the size/color specific size profile may be used. At the other end of the granularity spectrum, skirts may be allocated to a store based on a size profile that corresponds to a color-agnostic distribution of sizes for all ladies clothing items, if that is level of data granularity available for that store. This hierarchical treatment of size profiles allows for the most granular size profile to be used at the time of allocation. As the level of granularity of the size profile improves, so will the resulting allocation.

Finally, for retailers that do not have the processing power to generate detailed size profiles, the allocation can use historical sales of the SKUs to generate a profile. The difference in this historical sales based profile vs. using a size profile is that the historical generation method does not account for lost sales or smoothing across similar stores. Essentially the historical sales based profile still allows for detailed results and accounts for what was actually sold. The historical sales based profile does not account for what would have sold if allocation was perfect, which is the basis of more sophistical style profile generation.

The allocation tool 100 includes a size profile contribution logic 110, a strategy selection logic 120, and an allocation logic 130. When the allocation process begins, the allocation tool 100 receives a demand for a given item. The demand may be calculated by the allocation tool 100 by processing sales data. In some embodiments, the demand is provided by the user or some other computer component. In some embodiments, the demand is a projected demand based on seasonal factors and in other embodiments, the demand is based on a current sales curve for the item. The manner in which the demand is calculated does not affect the function of the allocation tool 100.

The size profile contribution logic 110 is configured to access a size profile that specifies a relative contribution of a plurality of SKUs for the item to overall sales of the item. For example, a size profile for a fashion item may be a size level profile that indicates that for every six items sold, one item is in size small, one item is in size medium, two items are in size small, and two items are in size extra large. The size profile contribution logic 110 is configured to determine respective SKU demand contributions for respective SKUs based, at least in part, on the size profile.

Based on the example size profile, SKU demand contributions of ⅙ for size small, ⅙ for size medium, ⅓ for size large, and ⅓ for size extra large are calculated. The size profile contribution logic 110 is configured to apply the respective SKU demand contributions to the demand quantity to calculate a plurality of SKU demands. Each respective SKU demand corresponds to demand for the item in the respective SKU. Based on the example size profile, if the demand is for twelve shirts, the size profile contribution logic 110 will determine a size small SKU demand of two items (⅙×12), a size medium SKU demand of two items (⅙×12), a size large SKU demand of four items (⅓×12), and a size extra large SKU demand of four items (⅓x 12).

The allocation logic 130 is configured to allocate a respective SKU allocation quantity for each respective SKU based, at least in part, on the corresponding SKU demand. The allocation logic 130 takes into account multi-SKU packs when making the allocation and selects an allocation that best matches the SKU demands. Multi-SKU packs may mean that exact combinations of SKUs to exactly meet the SKU demands are not available. For the given SKU demands, the allocation logic may be able to allocate either i) five of each size shirt, resulting in a total of twenty-five shirts, and an overstock of thirteen shirts or ii) one of each size shirt, resulting in a total of five shirts, and an under-stock of seven shirts. The allocation logic 130 may select the allocation that results in the least variance with respect to the SKU demands (e.g., allocation ii in the example).

The allocation logic 130 may optimize the allocation based on one or more additional inputs, which may be provided by a user using the allocation tool 100 or stored as a rule for the store for which allocation is being performed. In some embodiments, a SKU overage variance is provided as an input to the allocation tool 100. The SKU overage variance is a maximum amount by which an allocation can exceed the SKU demand. When allocation is performed, the allocation logic 130 allocates a respective SKU allocation quantity for each respective SKU based, at least in part, on the corresponding SKU demand. The allocation logic iteratively re-allocates the items when any SKU allocation quantity exceeds the corresponding SKU demand by more than the SKU overage variance until an allocation results in which no SKU allocation quantity exceeds the corresponding SKU demand by more than the SKU overage variance.

A substitution strategy may also be a factor in the allocation optimization performed by the allocation tool 100. The strategy selection logic 120 is configured to receive a strategy selection for item allocation that selects between honoring the SKU demand or not honoring the SKU demand. The strategy selection may be provided by a user using the allocation tool 100 or stored as a rule for a store for which allocation is being performed.

During the allocation calculation, when the strategy selection is to honor the SKU demand, the allocation logic 130 re-allocates the items when any SKU allocation quantity exceeds the corresponding SKU demand until an allocation results in which no SKU allocation quantity exceeds the corresponding SKU demand. This is done across all stores on the specific allocation. This strategy prevents overstock on any SKU and leaves open the possibility of not filling the entire demand for the combined SKUs or styles. When the strategy selection is selected as not honoring the SKU demand, the allocation logic 130 re-allocates the items when a sum of the SKU allocation quantities is less than the demand quantity until an allocation results in which the sum of the SKU allocation quantities meets the demand quantity. This strategy avoids under-filling demand but leaves open the possibility of overstocking some SKUs.

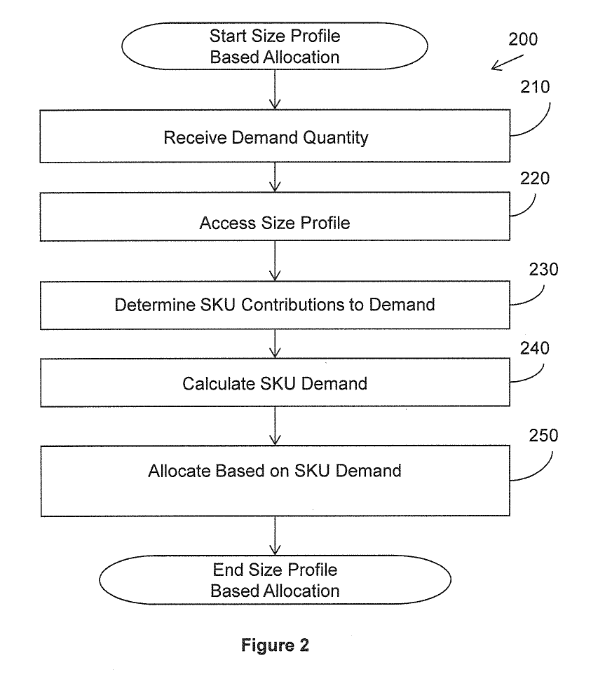

FIG. 2 illustrates one example embodiment of a method 200 for performing size profile based allocation. The method includes, at 210, receiving a demand quantity for an item sold in multiple SKUs. At 220, the method includes accessing a size profile that specifies a relative contribution of a plurality of SKUs to overall sales of the items. At 230, respective SKU demand contributions for respective SKUs are determined based, at least in part, on the size profile. At 240, the respective SKU demand contributions are applied to the demand quantity to calculate a plurality of SKU demands, where each respective SKU demand corresponds to demand for the item in the respective SKU. At 250, the method includes allocating items to fulfill the demand quantity for the item based, at least in part, on the plurality of SKU demands. In one embodiment, the method includes accessing a pack breakdown that specifies respective combinations of SKUs packaged in respective packs of items; and allocating items on a pack basis, based at least in part, on the pack breakdown.

In one embodiment, the method also includes allocating a respective SKU allocation quantity for each respective SKU based, at least in part, on the corresponding SKU demand and also receiving a strategy selection for item allocation that selects between honoring the SKU demand or not honoring the SKU demand. When the strategy selection comprises honoring the SKU demand, the method includes re-allocating the items when any SKU allocation quantity exceeds the corresponding SKU demand until an allocation results in which no SKU allocation quantity exceeds the corresponding SKU demand. If a SKU overage variance is specified, the method includes re-allocating the items when any SKU allocation quantity exceeds the corresponding SKU demand by more than the SKU overage variance until an allocation results in which no SKU allocation quantity exceeds the corresponding SKU demand by more than the SKU overage variance. When the strategy selection comprises not honoring the SKU demand, the method includes re-allocating the items when a sum of the SKU allocation quantities is less than the demand quantity until an allocation results in which the sum of the SKU allocation quantities meets the overall combined SKU demand quantity.

When the item is sold in multiple sizes and color combinations and each respective size and color combination corresponds to a unique SKU the method 200 may be adapted such that the accessing 220 is performed by accessing respective size/color level size profiles for respective colors that specify a relative contribution of a plurality of sizes in the respective colors to overall sales of the items. The determining 230 is performed by determining respective SKU demand contributions for respective size/color combinations for the item based, at least in part, on the color/size level size profiles. The applying 240 is performed by applying the respective SKU demand contributions to the demand quantity to calculate a plurality of size/color demands, where each respective size/color demand corresponds to demand for the item in the respective size and color combination. The allocating 250 is performed by allocating items based, at least in part, on the plurality of size/color demands. The method may also include accessing a pack breakdown that specifies respective combinations of colors and sizes packaged in respective packs of items; and allocating items on a pack basis, based at least in part, on the pack breakdown.

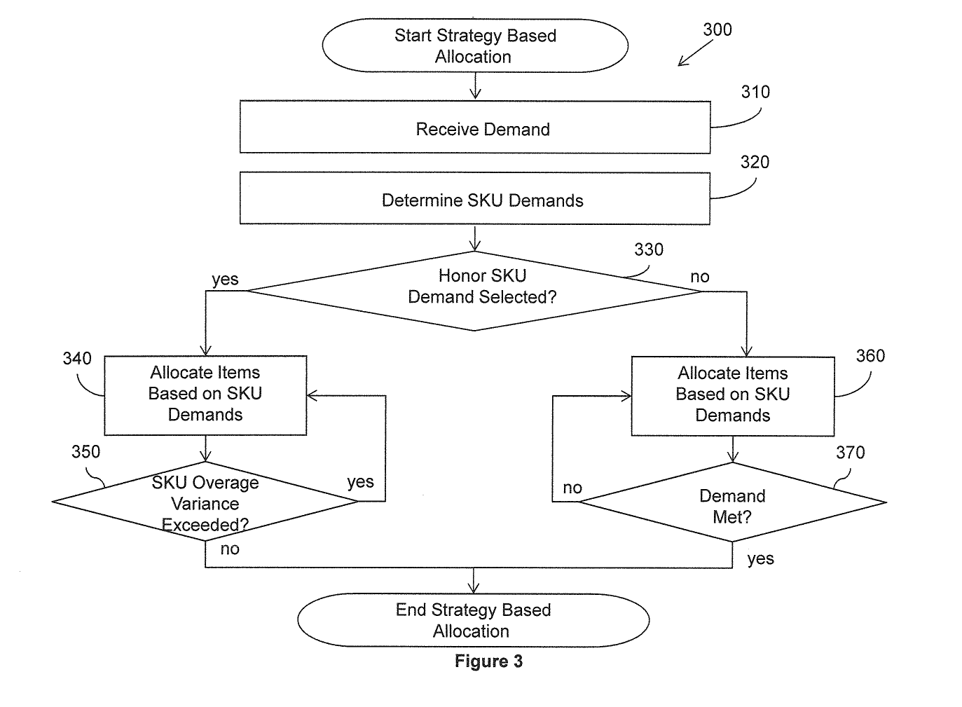

FIG. 3 illustrates an example of a method 300 for performing strategy-based allocation. The method includes, at 310, receiving a demand quantity for an item that includes multiple SKUs. At 320, the method determines a respective SKU demand quantity for each respective SKU for the item. In the embodiments described above, the SKU demand quantities were determined based on a size profile for the item. In method 300, the demand quantity can be determined using any method that distributes demand for an item amongst the item's several different SKUs. At 330, a determination is made as to which strategy selection has been made. Items are allocated based on the selected strategy.

In one embodiment, if the strategy of honor SKU demand has been selected, at 340, a respective SKU allocation quantity is allocated for each respective SKU based, at least in part, on the corresponding SKU demand. At 350, the items are re-allocated when any SKU allocation quantity exceeds the corresponding SKU demand by a predetermined amount. Re-allocation occurs until an allocation results in which no SKU allocation quantity exceeds the corresponding SKU demand by the predetermined amount. In the embodiment shown in FIG. 3, the predetermined amount is a SKU overage variance that is input by the user or stored as a rule for the store receiving the item being allocated.

If the strategy of not honoring the SKU demand is selected, at 360, a respective SKU allocation quantity is allocated for each respective SKU based, at least in part, on the corresponding SKU demand. At 370, the items are re-allocated when a sum of the SKU allocation quantities is less than the demand quantity. The re-allocation continues until an allocation results in which the sum of the SKU allocation quantities meets the demand quantity.

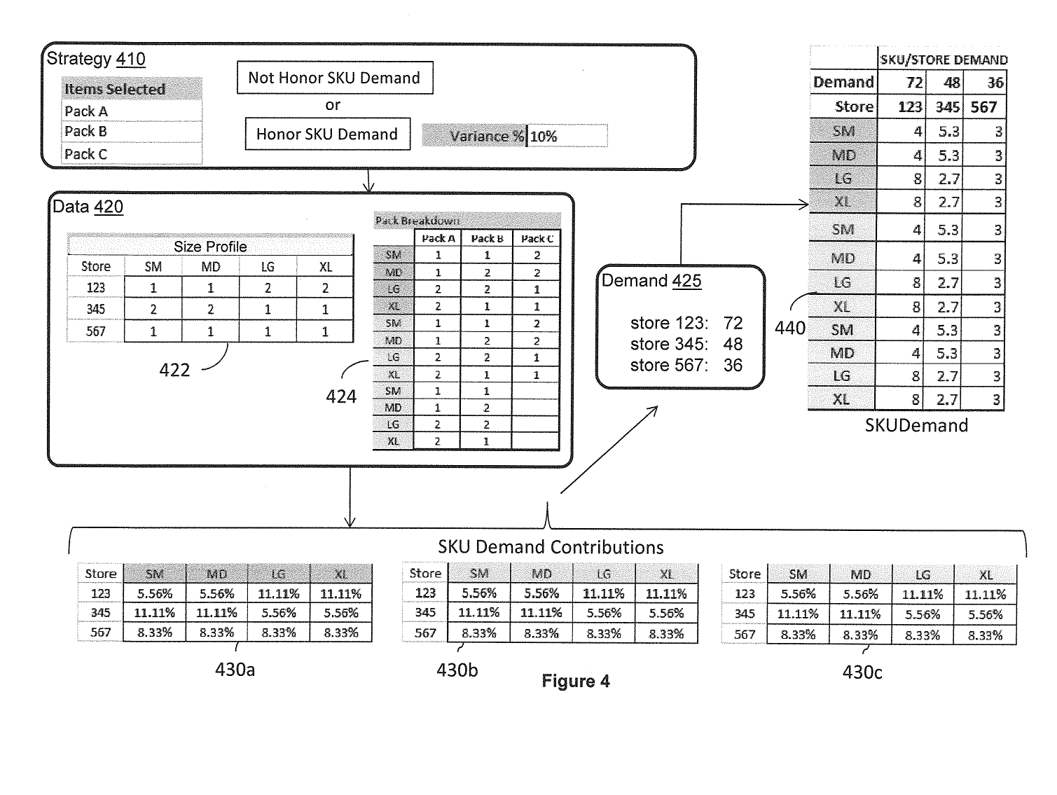

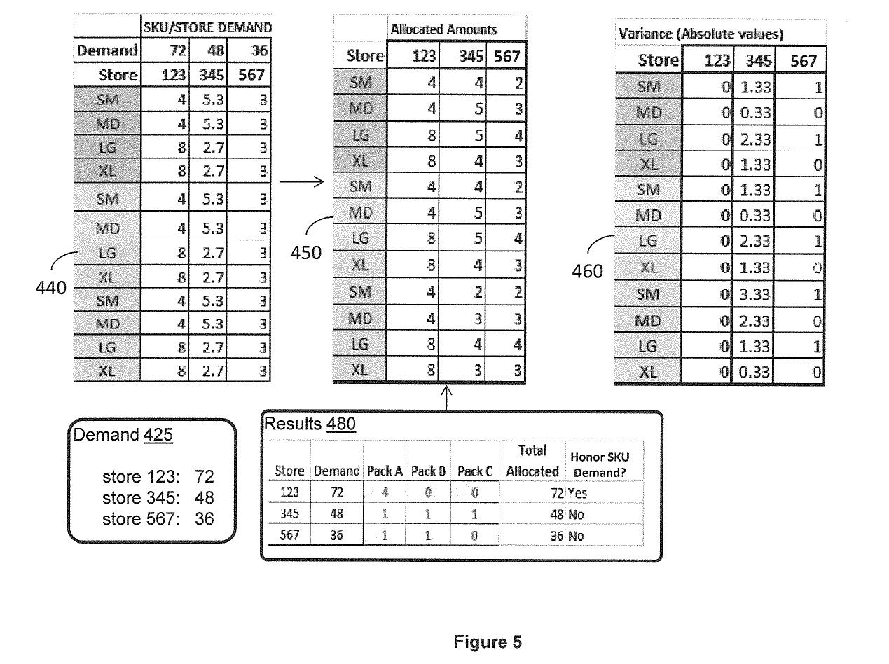

FIGS. 4 and 5 illustrate an example of one embodiment of the allocation tool 100 of FIG. 1 in operation to allocate packs of items among three stores. The user of the allocation tool is seeking to allocate retail items of a given style packaged in three configurations, Pack A, Pack B, and Pack C, to three stores 123, 345, and 567. The item comes in four sizes and three colors. Thus, the style includes twelve SKUs, one for each color and size combination. The allocation tool allocates the packs based on one or more strategies shown in box 410. One input strategy is to whether to honor the SKU demand and another strategy is selection of an acceptable SKU overage variance.

For each store, a selection is or has been made with respect to how the size profile is to be treated in the allocation process. The size profile based SKU demand can be either honored or not honored. For the purposes of this example, “honor SKU demand” has been selected for store 123 and “not honor SKU demand” has been selected for stores 345 and 567. The decision whether to honor the SKU demand is a business decision based on a store's sales strategy, and may have been made a priori and stored for use in allocation. For example, if a store's sales strategy is to mark products down significantly, a selection to not honor the SKU demand for the store would likely be made. Not honoring the SKU demand reduces the likelihood of running out of items to fill shelves at the cost of increasing the risk of overstocking an item.

If a store′ sales strategy is to avoid marking items down due to overstocking, a selection to honor the SKU demand for the store would likely be made. Honoring the SKU demand reduces the likelihood of overstocking an item at the cost of increasing the risk of running out of an item. In the illustrated embodiment, when “honor SKU demand” is selected, an acceptable level of SKU overage variance is also selected. The SKU overage variance is the amount by which an allocation quantity of an item may exceed a demand for the item as calculated using the size profile. In FIG. 4, the SKU overage variance is set to 10%. This means that the allocated quantity of any item cannot exceed SKU demand as calculated for the item using the size profile by more than 10%.

Data 420 stored for the various stores is used by the allocation tool. Size profile data 422 stored for each store is accessible to the allocation tool as well as pack breakdown information 424 about the contents of the various packs. The size profile data 422 indicates that store 123 typically sells twice as many large and extra-large items as small and medium items. Store 345 typically sells twice as many small and medium items as large and extra-large items. Store 567 sells an even distribution of items by size. Pack breakdown information 424 indicates that the items come in three colors (represented in FIGS. 4 and 5 by heavy shade/bold font, light shade/light font, light shade/bold font). Each pack includes 18 items with colors and sizes as shown in the chart 424.

Demand 425 for each store is also used by the allocation tool to allocate items. In FIG. 4, the demand 425 for store 123 is 72, the demand for store 345 is 48, and the demand for store 567 is 36. Note that the demand provided to the allocation tool is not broken down by size or color, but rather represents an aggregate number of items of the given style. Typically a user would have had to manually allocate packs to meet the total demand number for each style of item. The allocation tool and other systems and methods described herein allocate multi-color packs of items to best meet a store's total demand taking into account the particular store's size profile data 422 and strategies as selected in box 410.

A set of SKU demands 440 for each store, broken down by size and color is determined by the allocation tool. Because the size profile data 422 is at a size level (as opposed to having size/color level size profile, which may be available in some cases), the size profile is applied in a uniform manner to all colors and it is assumed that the demand is uniformly distributed amongst colors. Size profile based SKU demand contributions 430a, 430b, and 430c are calculated for each color. The SKU demand contributions are calculated as a percentage that each size/color combination contributes to overall demand.

For store 123, assuming that each color contributes 33.33% to demand, the size profile is used to determine the contribution of each size to the color's demand. Since small and medium each contribute ⅙ of the demand, the contribution for those sizes is calculated as ⅙(33.33) or 5.56%. Large and extra-large each contribute ⅓ of the demand for the color and the contribution for those sizes are calculated as ⅓(33.33) or 11.11%. The first row in the SKU demand contributions 430a, 430b, 430c shows the SKU demand contributions of Each color/size combination for store 123, the second row is for store 345, and the third row is for store 567.

In FIG. 4, because no color/size-specific size profiles were available, the size level size profile 422 was applied uniformly to all colors. If color/size level size profiles were available for all colors, those size profiles would be applied to the appropriate color/size combinations and the SKU demand contribution percentages would be different for sizes as between the colors. If color/size level size profiles are available for some, but not all colors, in one embodiment, the system uses the size level size profile as shown in FIG. 4 to calculate SKU demand contributions uniformly for all colors. A similar set of calculations is made for the other two stores 345 and 567 to determine the SKU demand contributions.

The SKU demand contributions 430a, 430b, 430c are applied to the demand for each store to calculate the SKU demand 440 for each size/color combination. In this manner, the calculated demand 440 is customized for each color/size combination for each store based on the store's size profile. The SKU demand 440 is input to an allocation algorithm that allocates packs to stores. The allocation algorithm has as inputs, each store's calculated demand 440, the pack breakdown 424, and each store's selection as to whether or not to honor the size profile and the SKU overage variance (e.g., from the strategy selections 210).

Referring now to FIG. 5, the allocation tool allocates the packs as shown in the results section 480. The numbers of items of each size/color combination can be seen in the allocated amounts box 450. It can be seen that store 123 is allocated the exact number of items for each size/color combination as were called for in the SKU demand 440. In allocating the packs, the allocation tool ensures that store 123 is not allocated more than 110% of the calculated demand for any size/color combination. This is because the strategy selection for store 123 is to honor the size profile with a maximum SKU overage variance of 10%.

In the example, the allocation results in 100% compliance in all size/color combinations for store 123. However, if it was not possible to allocate such that there was 100% compliance, an allocation that under-allocated with respect to the calculated demand by any amount would be chosen over an allocation that would result in an over-allocation of more than 110% in any size/color combination. For example, a pack allocation strategy that resulted in store 123 being allocated 5 small sized items in the first color would be rejected because this would be an allocation of 1.25% of the calculated demand.

The allocation tool also allocates packs to the other two stores 345 and 567, for which the size profile does not need to be honored and there is no limit on SKU overage variance. Thus the packs are simply allocated for those stores so that the stores' total demand number is met and variance from the store's size profile is minimized. Store 345 is under-allocated for the first color in small and medium and over-allocated for the first color in large and extra large. The absolute value of the variance in allocation with respect to the SKU demand is shown in box 460. Note that the SKU demand contributions 430a, 430b, 430c for a store can be used in subsequent allocations for the same item, facilitating future allocations. If the size profile for an item changes, new SKU demand contributions can be easily calculated.

As can be seen from the foregoing description, the tools, systems, and methods described herein introduce a size profile and/or a substitution strategy as inputs to an automatic allocation process. This greatly improves the flexibility that can be provided by the automatic allocation process.

### Computer Embodiment

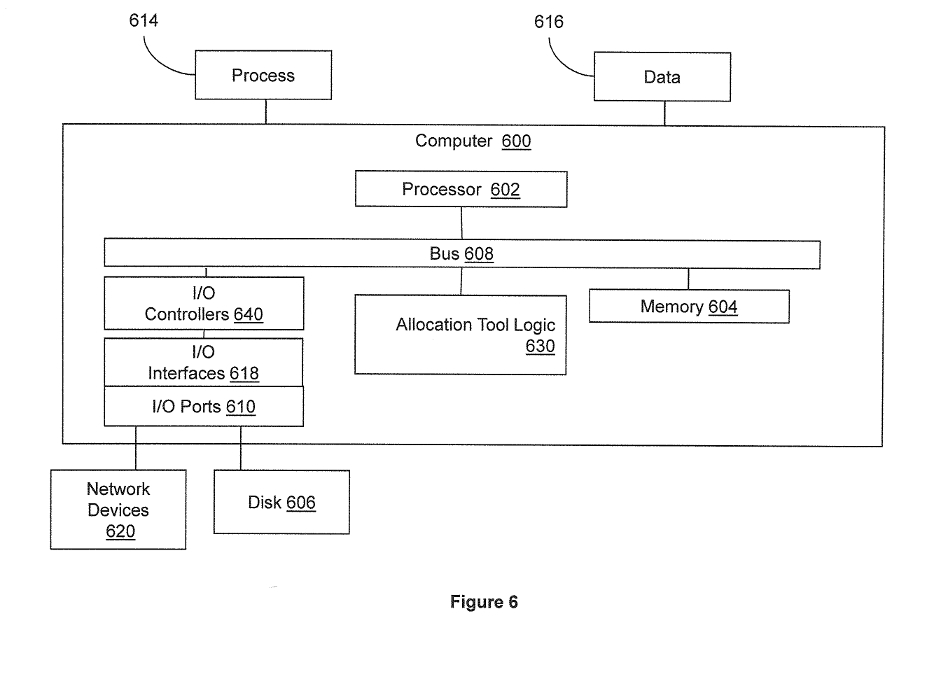

FIG. 6 illustrates an example computing device that is configured and/or programmed with one or more of the example systems and methods described herein, and/or equivalents. The example computing device may be a computer 600 that includes a processor 602, a memory 604, and input/output ports 610 operably connected by a bus 608. In one example, the computer 600 may include application tool logic 630 configured to facilitate allocating retail goods in the manner similar to the allocation tool 100 of FIG. 1 and/or the methods 200, 300 of FIGS. 2 and 3. In different examples, the allocation tool logic 630 may be implemented in hardware, a non-transitory computer-readable medium with stored instructions, firmware, and/or combinations thereof. While the allocation tool logic 630 is illustrated as a hardware component attached to the bus 608, it is to be appreciated that in one example, the allocation tool logic 630 could be implemented in the processor 602.

In one embodiment, logic 630 or the computer is a means (e.g., hardware, non-transitory computer-readable medium, firmware) for allocating retail goods based on a size profile and/or a substitution strategy.

The means may be implemented, for example, as an ASIC programmed to allocate retail goods based on a size profile and/or a substitution strategy. The means may also be implemented as stored computer executable instructions that are presented to computer 600 as data 616 that are temporarily stored in memory 604 and then executed by processor 602.

Logic 630 may also provide means (e.g., hardware, non-transitory computer-readable medium that stores executable instructions, firmware) for performing the method 200 of FIG. 2, the method 300 of FIG. 3, and/or the allocation technique exemplified in FIGS. 4 and 5.

Generally describing an example configuration of the computer 600, the processor 602 may be a variety of various processors including dual microprocessor and other multi-processor architectures. A memory 604 may include volatile memory and/or non-volatile memory. Non-volatile memory may include, for example, ROM, PROM, and so on. Volatile memory may include, for example, RAM, SRAM, DRAM, and so on.

A disk 606 may be operably connected to the computer 600 via, for example, an input/output interface (e.g., card, device) 618 and an input/output port 610. The disk 606 may be, for example, a magnetic disk drive, a solid state disk drive, a floppy disk drive, a tape drive, a Zip drive, a flash memory card, a memory stick, and so on. Furthermore, the disk 606 may be a CD-ROM drive, a CD-R drive, a CD-RW drive, a DVD ROM, and so on. The memory 604 can store a process 614 and/or a data 616, for example. The disk 606 and/or the memory 604 can store an operating system that controls and allocates resources of the computer 600.

The bus 608 may be a single internal bus interconnect architecture and/or other bus or mesh architectures. While a single bus is illustrated, it is to be appreciated that the computer 600 may communicate with various devices, logics, and peripherals using other busses (e.g., PCIE, 1394, USB, Ethernet). The bus 608 can be types including, for example, a memory bus, a memory controller, a peripheral bus, an external bus, a crossbar switch, and/or a local bus.

The computer 600 may interact with input/output devices via the i/o interfaces 618 and the input/output ports 610. Input/output devices may be, for example, a keyboard, a microphone, a pointing and selection device, cameras, video cards, displays, the disk 606, the network devices 620, and so on. The input/output ports 610 may include, for example, serial ports, parallel ports, and USB ports.

The computer 600 can operate in a network environment and thus may be connected to the network devices 620 via the i/o interfaces 618, and/or the i/o ports 610. Through the network devices 620, the computer 600 may interact with a network. Through the network, the computer 600 may be logically connected to remote computers. Networks with which the computer 600 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform any of the methods described with respect to FIGS. 1-5.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated. The methods described herein are limited to statutory subject matter under 35 U.S.C. §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium”, as used herein, is a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read. Computer-readable medium described herein are limited to statutory subject matter under 35 U.S.C. §101.

“Logic”, as used herein, includes a computer or electrical hardware component(s), firmware, a non-transitory computer readable medium that stores instructions, and/or combinations of these components configured to perform a function(s) or an action(s), and/or to cause a function or action from another logic, method, and/or system. Logic may include a microprocessor controlled by an algorithm, a discrete logic (e.g., ASIC), an analog circuit, a digital circuit, a programmed logic device, a memory device containing instructions that when executed perform an algorithm, and so on. Logic may include one or more gates, combinations of gates, or other circuit components. Where multiple logics are described, it may be possible to incorporate the multiple logics into one physical logic component. Similarly, where a single logic unit is described, it may be possible to distribute that single logic unit between multiple physical logic components. Logic as described herein is limited to statutory subject matter under 35 U.S.C. §101.

“User”, as used herein, includes but is not limited to one or more persons, computers or other devices, or combinations of these.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use. See, Bryan A. Garner, A Dictionary of Modern Legal Usage 624 (2d. Ed. 1995).

What is claimed is:

1. A non-transitory computer-readable medium storing computer-executable instructions that when executed by a computer cause the computer to perform a method, the method comprising:
receiving a demand quantity for an item sold in multiple SKUs;
accessing a size profile that specifies a relative contribution of a plurality of SKUs to overall sales of the items;
based, at least in part, on the size profile, determining respective SKU demand contributions for respective SKUs;
applying the respective SKU demand contributions to the demand quantity to calculate a plurality of SKU demands, where each respective SKU demand corresponds to demand for the item in the respective SKU; and
allocating items to fulfill the demand quantity for the item based, at least in part, on the plurality of SKU demands.

2. The non-transitory computer-readable medium of claim 1, where the item is sold in multiple sizes and color combinations and each respective size and color combination corresponds to a unique SKU.

3. The non-transitory computer-readable medium of claim 1, where the method further comprises:
receiving a strategy selection for item allocation; and
allocating the items based, at least in part on the selected strategy.

4. The non-transitory computer-readable medium of claim 3, where the method further comprises:
receiving a strategy selection for item allocation that selects between honoring the SKU demand or not honoring the SKU demand; and
when the strategy selection comprises honoring the SKU demand:
allocating a respective SKU allocation quantity for each respective SKU based, at least in part, on the corresponding SKU demand; and
re-allocating the items when any SKU allocation quantity exceeds the corresponding SKU demand until an allocation results in which no SKU allocation quantity exceeds the corresponding SKU demand.

5. The non-transitory computer-readable medium of claim 4, where the method further comprises receiving a SKU overage variance value for the item, further where:
the allocating comprises allocating a respective SKU allocation quantity for each respective SKU based, at least in part, on the corresponding SKU demand; and
the re-allocating comprises re-allocating the items when any SKU allocation quantity exceeds the corresponding SKU demand by more than the SKU overage variance until an allocation results in which no SKU allocation quantity exceeds the corresponding SKU demand by more than the SKU overage variance.

6. The non-transitory computer-readable medium of claim 3, where the method further comprises:
when the strategy selection comprises not honoring the SKU demand:
allocating a respective SKU allocation quantity for each respective SKU based, at least in part, on the corresponding SKU demand; and
re-allocating the items when a sum of the SKU allocation quantities is less than the demand quantity until an allocation results in which the sum of the SKU allocation quantities meets the demand quantity.

7. The non-transitory computer-readable medium of claim 1, where the method further comprises:
accessing a pack breakdown that specifies respective combinations of SKUs packaged in respective packs of items; and
allocating items on a pack basis, based at least in part, on the pack breakdown.

8. The non-transitory computer-readable medium of claim 1, where:
the item is sold in multiple sizes and color combinations and each respective size and color combination corresponds to a unique SKU;
the accessing comprises accessing respective size profiles for respective colors that specifies a relative contribution of a plurality of sizes in the respective colors to overall sales of the items;
the determining comprises determining respective SKU demand contributions for respective size and color combinations for the item based, at least in part, on the size profiles for respective colors;
the applying comprises applying the respective SKU demand contributions to the demand quantity to calculate a plurality of size/color demands, where each respective size/color demand corresponds to demand for the item in the respective size and color combination; and
the allocating comprises allocating items based, at least in part, on the plurality of size/color demands.

9. A computing system, comprising:
a processor;
an allocation logic configured to cause the processor to receive a demand quantity for an item sold in multiple SKUs; and
a size profile contribution logic configured to cause the processor to:
access a size profile that specifies a relative contribution of a plurality of SKUs to overall sales of the items;
based, at least in part, on the size profile, determining respective SKU demand contributions for respective SKUs; and
applying the respective SKU demand contributions to the demand quantity to calculate a plurality of SKU demands, where each respective SKU demand corresponds to demand for the item in the respective SKU;
where the allocation logic is configured to cause the processor to allocate items to fulfill the demand quantity for the item based, at least in part, on the plurality of SKU demands.

10. The computing system of claim 9, where:
the item is sold in multiple sizes and color combinations and each respective size and color combination corresponds to a unique SKU;
the size profile contribution logic is configured to cause the processor to:
determine respective SKU demand contributions for respective size and color combinations for the item; and
apply the respective SKU demand contributions to the demand quantity to calculate a plurality of size/color demands, where each respective size/color demand corresponds to demand for the item in the respective size and color combination; and
the allocation logic is configured to cause the processor to allocate items based, at least in part, on the plurality of size/color demands.

11. The computing system of claim 9, further comprising:
a strategy selection logic configured to cause the processor to receive a strategy selection for item allocation that selects between honoring the SKU demand or not honoring the SKU demand; and
where the allocation logic is configured to cause the processor to, when the strategy selection comprises honoring the SKU demand:
allocate a respective SKU allocation quantity for each respective SKU based, at least in part, on the corresponding SKU demand; and
re-allocate the items when any SKU allocation quantity exceeds the corresponding SKU demand until an allocation results in which no SKU allocation quantity exceeds the corresponding SKU demand.

12. The computing system of claim 9, where:
the size profile contribution logic is configured to cause the processor to receive a SKU overage variance value for the item; and
the allocation logic is configured to cause the processor to:
allocate a respective SKU allocation quantity for each respective SKU based, at least in part, on the corresponding SKU demand; and
re-allocate the items when any SKU allocation quantity exceeds the corresponding SKU demand by more than the SKU overage variance until an allocation results in which no SKU allocation quantity exceeds the corresponding SKU demand by more than the SKU overage variance.

13. The computing system of claim 11,
where the allocation logic is configured to cause the processor to, when the strategy selection comprises not honoring the SKU demand:
allocate a respective SKU allocation quantity for each respective SKU based, at least in part, on the corresponding SKU demand; and
re-allocate the items when a sum of the SKU allocation quantities is less than the demand quantity until an allocation results in which the sum of the SKU allocation quantities meets the demand quantity.

14. The computing system of claim 9, where:
the item is sold in multiple sizes and color combinations and each respective size and color combination corresponds to a unique SKU;
the size profile contribution logic is configured to:
access respective size profiles for respective colors that specify a relative contribution of a plurality of SKUs in the respective colors to overall sales of the items;
determine respective SKU demand contributions for respective size and color combinations for the item based, at least in part, on the size profiles for respective colors; and
apply the respective SKU demand contributions to the demand quantity to calculate a plurality of size/color demands, where each respective size/color demand corresponds to demand for the item in the respective size and color combination; and
the allocation logic is configured to cause the processor to allocate items based, at least in part, on the plurality of size/color demands.

15. The computing system of claim 9, where the allocation logic is configured to cause the processor to:
access a pack breakdown that specifies respective combinations of SKUs packaged in respective packs of items; and
allocate items on a pack basis, based at least in part, on the pack breakdown.

16. A non-transitory computer-readable medium storing computer-executable instructions that when executed by a computer cause the computer to perform a method, the method comprising:
receiving a demand quantity for an item that includes multiple SKUs;
determining a respective SKU demand quantity for each respective SKU for the item;
accessing a strategy selection associated with the item, where the strategy selection specifies whether allocation should honor the SKU demand or not honor the SKU demand; and
allocating the item based, at least in part, on the strategy selection and the determined SKU demand quantities.

17. The non-transitory computer-readable medium of claim 16, where the method includes, when the strategy selection comprises honoring the SKU demand:
allocating a respective SKU allocation quantity for each respective SKU based, at least in part, on the corresponding SKU demand; and
re-allocating the items when any SKU allocation quantity exceeds the corresponding SKU demand until an allocation results in which no SKU allocation quantity exceeds the corresponding SKU demand.

18. The non-transitory computer-readable medium of claim 17, where the method further comprises receiving a SKU overage variance value for the item, further where:
the re-allocating comprises re-allocating the items when any SKU allocation quantity exceeds the corresponding SKU demand by more than the SKU overage variance until an allocation results in which no SKU allocation quantity exceeds the corresponding SKU demand by more than the SKU overage variance.

19. The non-transitory computer-readable medium of claim 16, where the method includes, when the strategy selection comprises not honoring the SKU demand:
allocating a respective SKU allocation quantity for each respective SKU based, at least in part, on the corresponding SKU demand; and
re-allocating the items when a sum of the SKU allocation quantities is less than the demand quantity until an allocation results in which the sum of the SKU allocation quantities meets the demand quantity.

20. The non-transitory computer-readable medium of claim 16, where the SKU demands are calculated based on a size profile for the item that specifies a relative contribution of a plurality of SKUs to overall sales of the items.
